(19) United States
(12) Patent Application Publication
(10) Pub. No.: US 2007/0244784 A1
(43) Pub. Date: Oct. 18, 2007

(54) Method for transferring monies, coinciding with unrelated transactions, to a designated account

(76) Inventor: David C. Nowacek, San Antonio, TX (US)

Correspondence Address: KAMMER BROWNING PLLC, 7700 BROADWAY, SUITE 202, SAN ANTONIO, TX, 78209, US

(21) Appl. No.: 11/787,221

(22) Filed: Apr. 14, 2007

Related U.S. Application Data
(60) Provisional application No. 60/792,229, filed on Apr. 14, 2006.

(51) Int. Cl. G06Q 40/00

(52) U.S. Cl. 705/35

(57) ABSTRACT

A method to increase savings by individuals based upon a percentage or portion of transactions made. In its most basic form, the method allows the participant to elect to have a small amount added to the charge for each non-cash transaction. The method of the present invention incorporates the calculation of a small, savings amount based upon the amount of a qualified transaction. The savings amount is added to the transaction amount to give a total amount for the participant's accounting and statement purposes, but it is not incorporated into the transaction payment. Instead, it is split off and transferred to a designated account that the participant chooses. Additionally, the financial institution, retailer, or other business entities involved in the transaction may elect to make some form of matching contribution to the participant's account as a form of promotion. The present invention benefits the participant by transferring small amounts from a highly used account to an account that the participant intends to use for saving purposes. Such an account may be any account chosen by the participant, but will generally be a savings type account, retirement account, an account that the participant has set aside to build up funds for a particular purpose, or an altruistic type account, such as a college fund for a child.

### CROSS REFERENCE TO RELATED APPLICATIONS

This Application claims the benefit under Title 35 United States Code §119(e) of U.S. Provisional Patent Application Ser. No. 60/792,229, filed Apr. 14, 2006, the full disclosure of which is incorporated herein by reference.

### BACKGROUND OF THE INVENTION

1. Field of the Invention

The present invention relates generally to methods and apparatuses for transferring monies to a specified account as unrelated financial transactions occur. More specifically, the invention relates to systems, methods, and computer programs for computing small amounts of money based upon a given transaction and transferring said small amount of money to a specified account, thus creating a savings method.

2. Description of the Related Art

As a general statement, people in the United States have become a consumer oriented, non-saving group. Savings, although as important as ever, are reducing at the individual level in a time of national prosperity. Societal priorities that once placed savings on a pedestal have fallen by the wayside and are being replaced by consumerism. It is all too common that people live paycheck to paycheck, spending virtually their entire income and saving very little. Surprisingly, this is not limited to individuals and families of low incomes. Often, those with higher incomes choose to spend more as their incomes increase. Thus, even those with relatively high incomes may find their savings remarkably low.

There are many well-known practices designed to encourage savings. These can take the form of anything from financial accounts for the individual to group retirement plans and the like. Even retail businesses use “savings” to encourage more purchases. Sales, discounts, and specials are all designed to “save” the consumer money. In this manner, savings are constantly on the consumers' mind.

One savings method that has been taken advantage of in the home, has been “empty the pockets” of spare change at the end of a day into a jar. For example, a person may come home from work after having made various purchases during the day with several coins in their pocket. And, rather than keep putting more and more coins in their pocket each day that would often not be used, the person places the spare change in a jar. Generally, the amount of the change is relatively small, and the person sees the nuisance of carrying the weight of the change as greater than the value of the change itself. Larger denomination, paper bills have been spent, and the change is likely not seen has having enough value to purchase additional desired goods or services. Placing the spare change in the jar is relatively “painless,” because a person, who has just used a twenty dollar bill to pay a $19.35 transaction, from a psychological viewpoint, is likely to view the entire $20.00 as already spent. While a single day's contribution may be relatively small, when done over days, weeks, months, and even years, the total can add up to a considerable sum. Many children have used this technique to wheedle money from parents, and individuals have seen wished for items that they could not justify paying for become affordable due to this type of saved up, “spent” money.

Unfortunately, this technique for saving money has traditionally been relegated to small scale happenstance in the home, and has not been utilized on a planned, commercial basis. The present invention takes this basic idea, and applies a unique method to encourage savings by individuals. Specifically, the invention relates to a method for financial institutions and individuals to work jointly to increase the individuals' savings. The method benefits the business and financial entities by providing a relatively inexpensive promotional tool.

### SUMMARY OF THE INVENTION

The present invention includes a method which is designed to increase savings by individual participants based upon a percentage or portion of transactions made. In its most basic form, the present invention allows the participant to elect to have a small amount added to the charge for each non-cash transaction. The method of the present invention incorporates the calculation of a small, savings amount based upon the amount of any given qualified transaction. The savings amount is added to the transaction amount to give a total amount for the participant's accounting and statement purposes, but it is not incorporated into the transaction payment. Instead, it is split off and transferred to a designated account that the participant chooses. Additionally, the financial institution, retailer, or other business entities involved in the transaction may elect to make some form of matching contribution to the participant's account as a form of promotion. The present invention benefits the participant by transferring small, unnoticeable amounts from a highly used account to an account one that the participant intends to use for saving purposes. Such an account may be any account chosen by the participant, but will generally be a savings type account, retirement account, an account that the participant has set aside to build up funds for a particular purpose, or an altruistic type account, such as a college fund for a child.

It is an object of the present invention to provide a system that adds a small amount to the cost of each eligible transaction of a participant and transfer the small amount to a designated account.

It is a further object of the present invention to allow modifications to each part of the system such that each individual participant can customize the system to their specific needs.

It is a further object of the present invention to create a savings system for participants that can be used as a marketing tool by financial institutions, retailers, and marketers.

It is a further object of the present invention that the system be controlled by software programs.

In some of the descriptions that follow, the present invention is intended to be controlled by, and therefore is presented, partly in terms of process steps and operations of data bits within a computer memory. These algorithmic descriptions and representations are the means used by those skilled in the art to convey the substance of their work to others skilled in the art.

An algorithm is here, and generally, conceived to be a self-consistent sequence of steps leading to a desired result. These steps are those requiring physical manipulations of physical quantities. Usually, although not necessarily, these quantities take the form of electrical, magnetic, optic, or other signals capable of being stored, transferred, combined, compared, displayed, and otherwise manipulated. These signals may be referred to, at times, as bits, values, elements, symbols, characters, images, terms, numbers, data, input, output, information, or the like, in order for convenience and for purposes of common usage. However, all of these references are associated with physical quantities and are merely convenient labels applied to these quantities.

In the present invention, some of the operations referred to are automated, machine operations performed in conjunction with a human operator. Useful machines for performing the operations and providing the means of the present invention include dedicated purpose computers, general purpose computers, or other similar devices. The present invention relates to the methods for operating such devices, and processing electrical, magnetic, optic, or other physical signals to generate desired physical results.

The present invention also relates to apparatus for performing these operations. The apparatus may be specially constructed for the required purposes or it may comprise a general purpose computer selectively controlled or reconfigured by a computer program stored in the memory of the computer. The method presented herein is not inherently related to any particular computer or other apparatus. Similarly, no particular computer programming language is required. The required structure, although not machine specific, will be apparent from the description herein.

### BRIEF DESCRIPTION OF THE DRAWINGS

The invention will be better understood and objects other than those set forth above will become apparent when consideration is given to the following detailed description of the preferred embodiments. Such description makes reference to the annexed drawings wherein:

FIG. 1 is a flowchart illustrating an overview of the present invention.

FIG. 2 is a flowchart illustrating multiple transactions processed by the present invention.

FIG. 3 is a flowchart illustrating alternative processes of the present invention.

FIG. 4 is a flowchart illustrating the database maintenance of the present invention,

FIG. 5 is a flowchart illustrating the processing of business entities participating in the present invention.

FIG. 6 is a flowchart illustrating the monthly statement processing of the present invention.

FIG. 7 is a flowchart illustrating financial entity processing of the present invention.

FIG. 8 is a flowchart illustrating the period end participant billing process of the present invention.

FIG. 9 is a flowchart illustrating processing for a personal checking account of the present invention.

### DETAILED DESCRIPTION OF THE PREFERRED EMBODIMENT

Turning to the figures, it may be seen that the present invention is highly modifiable to accommodate and benefit the unique needs of each of the participant, the business entity, and the financial entity.

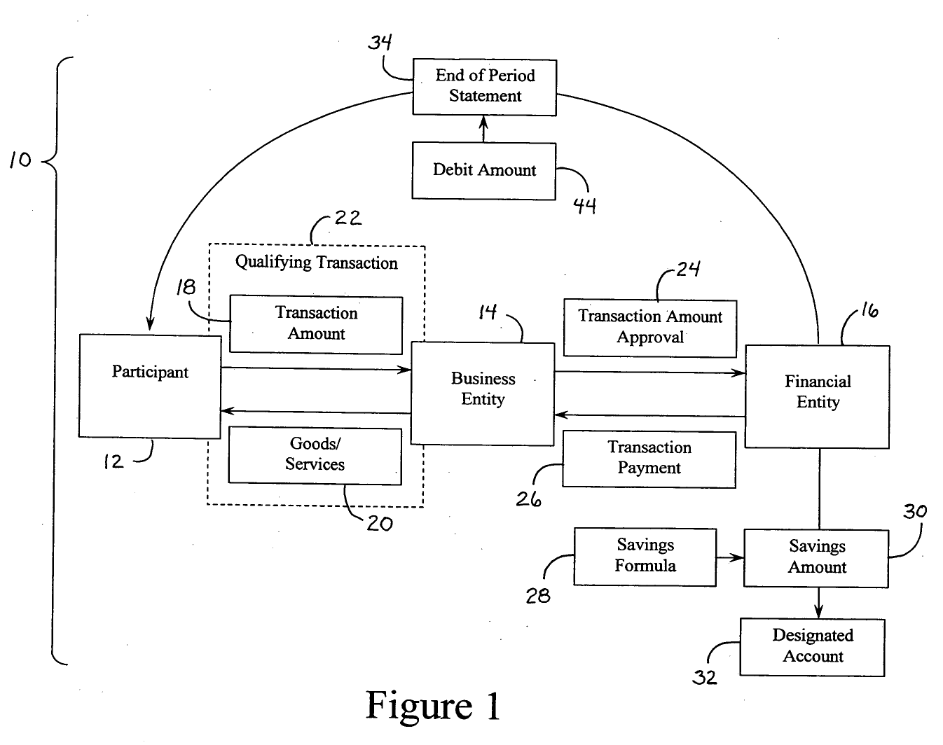

FIG. 1 is a flowchart illustrating an overview of the savings method (10) of the present invention. It shows a participant (12) who has entered into a qualified transaction (22) with a business entity (14). The qualified transaction (22) consists of the participant (12) choosing a good or service (20) having a specified transaction amount (18). The participant (12) receives the good or service (20) from the business entity (14) and pays the transaction amount (18) using a non-cash form of payment. In order for the qualified transaction (22) to be “qualified,” or included for calculation within the savings method (10), the form of payment must made using a pre-designated, non-cash form of payment. There are several forms of payment which can be used, including without limitation, checks, debit cards, or credit cards.

In order to receive funds for the goods or services (20) sold to the participant (12), the business entity (14) communicates the transaction amount approval (24) to the financial entity (16), and if approved for payment, the financial entity (16) transfers the transaction payment (26) to the business entity. The financial entity (16) recognizes the qualified transaction (22) as qualified and stores the qualified transaction (22) in its normal course.

Prior to providing the participant (12) with the participant's (12) end-of-period statement (34), whether in the form of statement of account such as for a checking account, or in the form of an invoice such as for a credit card bill, the financial entity (16) calculates a savings amount (30) based upon the qualified transaction (22). The calculation is made pursuant to a preset savings formula (28). Any number of preset savings formulae (28) may be used. In one instance, the savings formula (28) may incorporate a simple rounding to the next even dollar amount. For example, if the transaction amount (18) was $19.35, then the savings amount (30) would be found by subtracting the transaction amount (18) from the next even dollar amount, giving a savings amount (30) of 65¢, or: $20.00-$19.35=$0.65. In another instance, the savings amount (30) may be calculated based upon a percentage of the transaction amount (18). For example, the participant (12) might have chosen a 1% savings modifier, making the savings amount (30) on the above $19.35 qualified transaction (22) equal to 19¢0, or: $19.35×0.01=$0.19. Obviously, in the first example, the savings amount (30) will always be equal to, or less than $1.00, while the savings amount (30) in the second example can amount to a substantial sum if the transaction amount (18) is high. Thus, the participant can set upper, or even lower, limits to ensure that the savings amount (30) is never more than desired. Or, the savings amount may be a set figure that can be increased incrementally with increasing transaction amounts (18). It is contemplated that the savings formula (28) can be determined by any criteria that are desired by the participant (12) and agreeable to the financial entity (16).

Upon determining the savings amount (30), and in the normal course of business, the financial entity (16) will bill the participant in the end of period statement (34) for the debit amount (44) which consists of the total of the transaction amount (18) plus the savings amount (30). The billing may take the form of a transfer of funds, such as with a checking account or debit card, or an invoice to the participant (12), such as with a credit card. The financial entity (16) will also transfer funds in the amount of the savings amount (30) to a designated account (32), identified by the participant to receive such funds.

The saving method (10) will cause the deposit of funds from an account that will generally be a highly used account, to the designated account (32) in a relative painless and invisible manner. Ideally, the designated account will be of a type that the participant will be encouraged to maintain and allow to grow, thus increasing the savings of the participant (12).

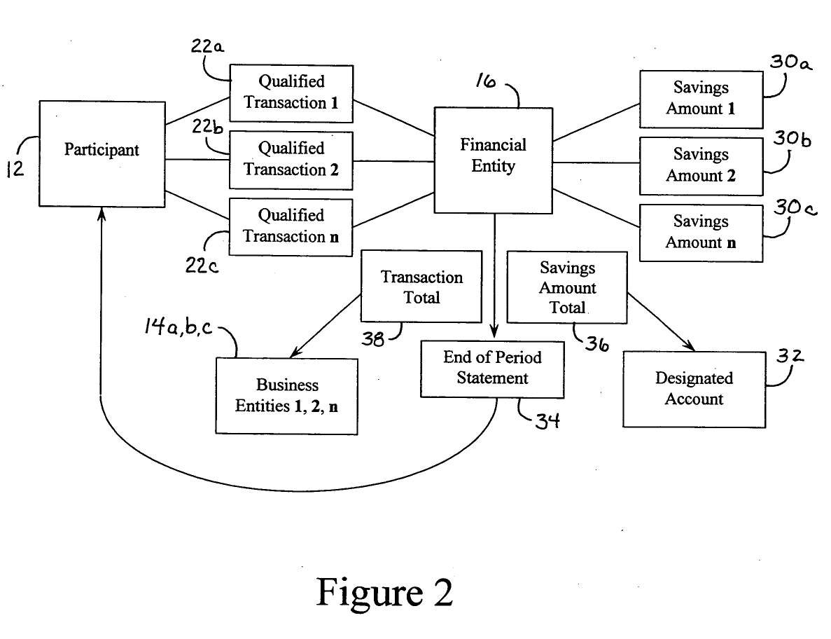

FIG. 2 is a flowchart illustrating multiple transactions processed by the saving method (10). In this figure, a participant (12) has engaged in an unidentified number “n” of qualified transactions (22) in a given time period, represented as qualified transaction 1 (22a), qualified transaction 2 (22b), thru qualified transaction n (22c). The saving method (10) is applied individually to each qualified transaction (22a, b, and c) in the manner as described herein, but must deal with all n transactions. The participant (12) engages in n qualified transactions (22), which are communicated to the financial entity (16). The financial entity (16) calculates a savings amount (30) for each qualified transaction (22). i.e. Savings amount 1 (30a) is calculated based upon the amount qualified transaction 1 (22a), savings amount 2 (30b) is calculated based upon qualified transaction 2 (22b), and so on, until savings amount n (30c) is calculated based upon the last qualified transaction n (22c) of the relevant time period. The financial entity (16) saves in its records, the individual qualified transactions (22a, b, and c) and the savings amounts (30a, b, and c). Prior to generating an end of period statement (34), the financial entity calculates the sum of qualified transactions I through n (22a, b, and c) as the transaction total (38), and calculates the sum of the savings amounts 1 through n (30a, b, and c) as the savings amount total (36). The transaction total represents all amounts paid to business entities (14), and the savings amount total (36) is transferred to the designated account (32). The end of period statement (34) is communicated to the participant (12) and represents the sum of the transaction total (38) and the savings amount total (36), as well as any non-qualified transactions (not depicted).

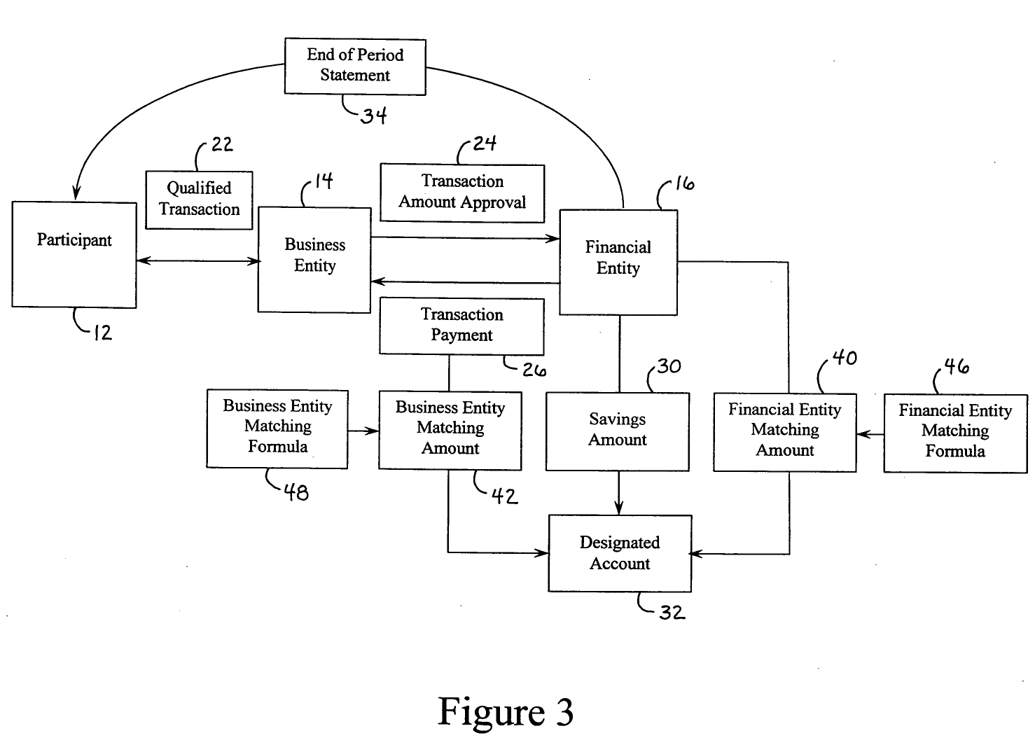

FIG. 3 is a flowchart illustrating alternative processes of the saving method (10). It is anticipated that the saving method (10) may be employed by various business entities (I4) and financial entities (16) as a marketing tool to entice consumers to purchase or use their goods and services. As with other services, the saving method (10) could be advertised as a feature of the entity (14 or 16), and a convenience to the participant (12). As additional incentive, these entities (14 and 16) may offer to match, or partially match, the participants' (12) savings amounts (30) into the designated accounts (32).

A financial entity (16), such as a bank or credit card company, could offer a financial entity matching amount (40) to go along with the participant's (12) savings amount (30). The financial entity matching amount (40) would be calculated based upon the savings amount (30) as modified by a financial entity matching formula (46). Like the savings formula (28), the financial entity matching formula (46) can be any mathematical formula approved by the financial entity, and can be changed for different time periods. Using the example set forth above in which a qualified transaction (22) having a transaction payment (26) of $19.35 was made and the participant (12) had a resulting savings amount (30) of 65¢, the financial entity could choose a financial entity matching formula (46) of a specific percentage, such as 100% or 50% of the savings amount (30), in which case the financial entity (16) would contribute 65¢ or 33¢ respectively. The financial entity matching amount can also be based upon the original transaction amount (18). Financial entities would be free to employ lots of matching strategies and marketing campaigns, such as “new participant,” “holiday,” “anniversary,” “children's,” or other promotions. This benefits the participant (12) by adding the financial entity matching amount (40) to the savings amount (30) for deposit into the designated account (32). It benefits the financial entity (16) by enticing the participant (12) to use the financial entity's (16) services rather than a competitor's, and encourage the participant to enter into qualified transactions (22) more often.

A business entity (14) can also take advantage of the same sort of promotions. Like a promotion for a financial entity (16), a business entity (14) may advertise the fact that it will “match” savings amounts (30) to entice customers to purchase the business entity's (14) goods or services (20). Also like the financial entity (16), the business entity (14) uses a business entity matching formula (48) to calculate a business entity matching amount (42), and the formula (48) can be modified at will by the business entity (14). The main difference is that the business entity must communicate to the financial entity (16) the business entity's (14) intention to add the business entity matching amount (42) to the participant's (12) savings amount (30) for deposit into the designated account (32).

To help clarify the savings method's (10) overall possibility, recognizing that many other embodiments are intended and modifications may be made as described herein, the previously used example can again be examined. Assuming a participant (12) made a qualified transaction (22) having a transaction amount (18) of $19.35, and used a simple savings formula (28) of rounding up to the next whole dollar amount to calculate a savings amount (30). Further, assume the financial entity (16) has agreed to match the savings amount (30) using a financial entity matching formula (46) of 100%, while the business entity has agreed to match the savings amount (30) using a business entity matching formula (46) of rounding down to the next whole dollar amount to calculate a business entity matching amount (42). Thus, the participant's (12) savings amount (30) is 65¢, the financial entity matching amount (40) is 65¢, and the business entity matching amount (42) is 35¢. The participant (12) pays $20.00 for a $19.35 good or service (20), or 65¢ extra, but receives a $1.65 deposit in the participant's (12) designated account (32). The financial entity (16) and the business entity (14) also each pay a minimal amount, but have enticed the participant to use or purchase their goods or services, as opposed to a competitor's.

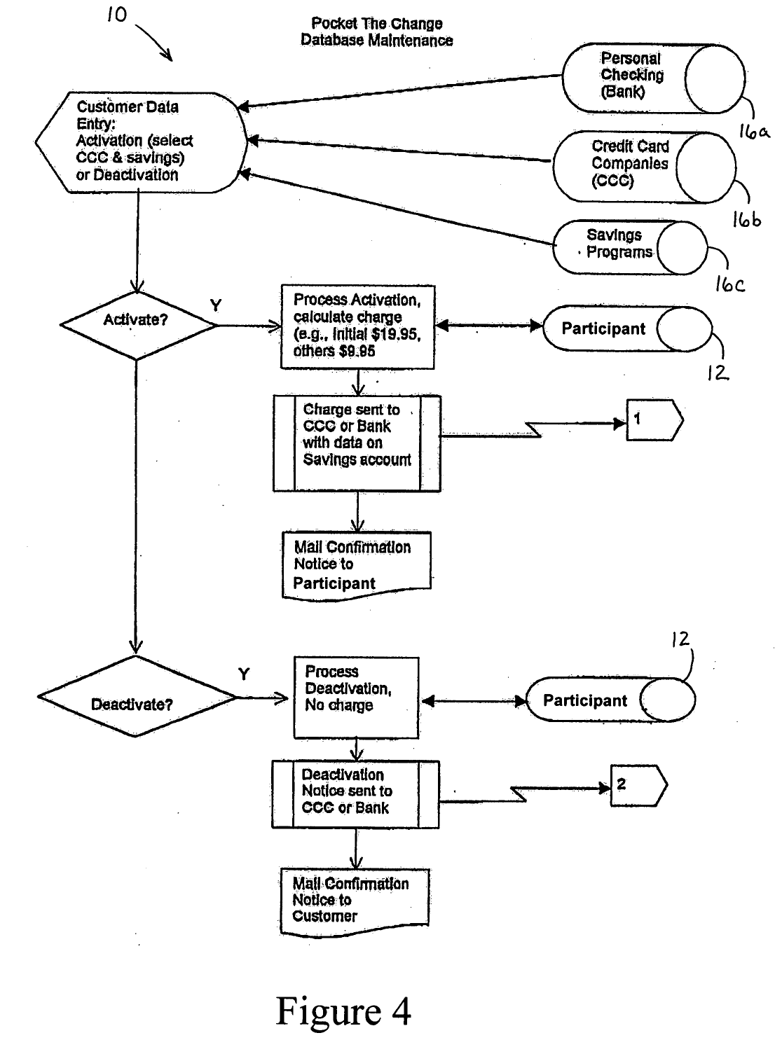

FIG. 4 is a flowchart illustrating the database maintenance of the present invention and the processing steps for activation and deactivation of the savings method (10). The savings method (10) is initiated and terminated by a sequence of process steps that query the participant (12) for a response. Initiation of the savings method (10) is accomplished by receiving account information from the participant (12) regarding the participant's financial entity's (16). Such financial entity's (16) may include, but are not limited to, banks (16a), credit card companies (16b), and savings programs (16c). The participant (12) then makes a decision to activate the savings method (10). Upon process activation, an initiation charge may be calculated and billed to the participant (12). The charge is sent to a selected financial entity (16) and finally, a confirmation notice may be transmitted to the participant (12).

Should the participant (12) wish to deactivate the savings method (10), the financial entity's (16) are notified and a confirmation notice may be transmitted to the participant (12).

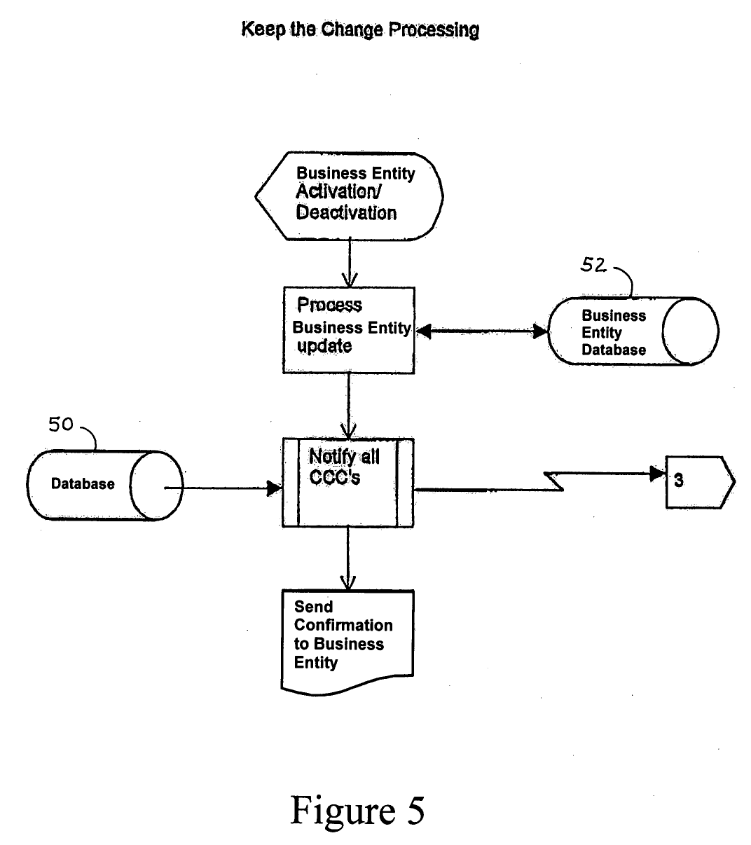

FIG. 5 is a flowchart illustrating the processing of business entities (14) participating in the savings method (10). It is not required that business entity (14) participate in the savings method (10). The savings method (10) may be administered using only sales calculations at the financial entities (16). However, the savings method (10) allows for business entities to also participate. To be included, the business entity (14) chooses to activate its inclusion in the savings method (10) by notifying various financial entities (16). Thus, the business entity is included in a business entity database (52) such that if a qualified transaction (22) is made at the participating business entity (14), the financial entity (16) is notified and the business entity (14)'s contribution is included in the savings method (10). Upon activation by the business entity (14), a confirmation may be transmitted to the business entity (14). The business entity (14) may choose to deactivate its inclusion in the savings method (10) by notifying the financial entity (16).

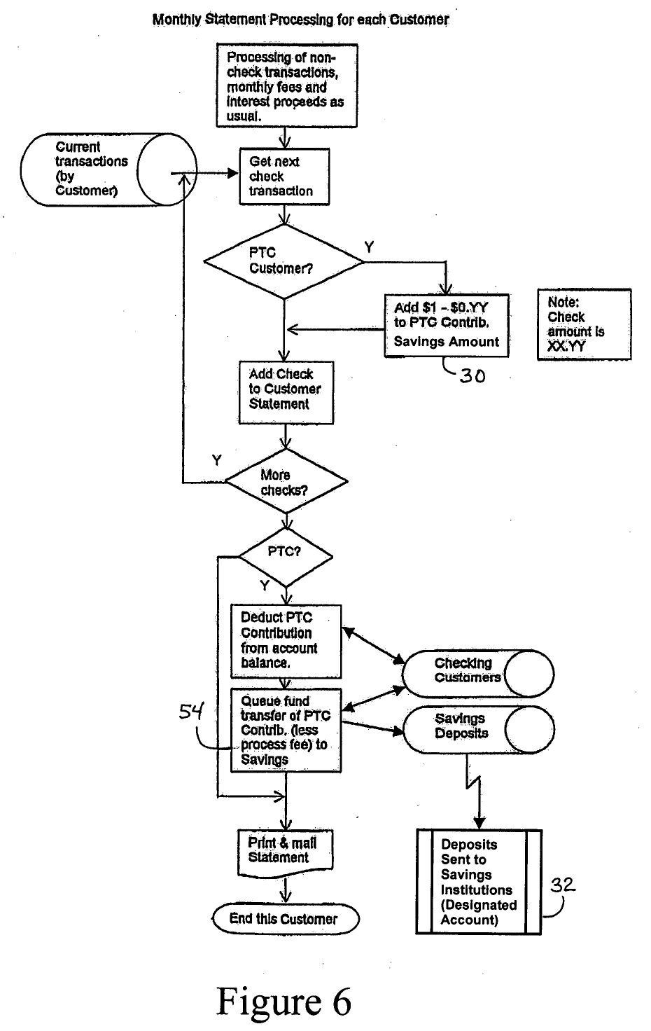

FIG. 6 is a flowchart illustrating the monthly statement processing for each participant (12). Financial entity (16) generally account for and process a participant (12)'s transactions on a monthly basis. The savings method (10) may be processed during the financial entities (16) normal processing. As each account holder of the financial entity is processed, a decision is made by comparing the financial entities (16) customer to see if the customer is a participant (12) in the savings method (10). If so, a savings amount (30) is calculated and added to the participant's statement. As each transaction is accounted for, the next transaction is checked to see if it is a qualified transaction (22) and whether it should be included in the savings method (10) calculation as well. After all of the qualified transactions (22) have been accounted for, the total savings amount is deducted from the specified accounts of the participant (12)'s within the financial entities (16). This amount is then transferred to the designated account (32). Additionally, a processing fee (54) may be deducted from the participant (12)'s total savings amount (30). Finally, an end of period statement of the total savings amount (30) and the balance of the designated account (32) may be created and transferred to the participant (12).

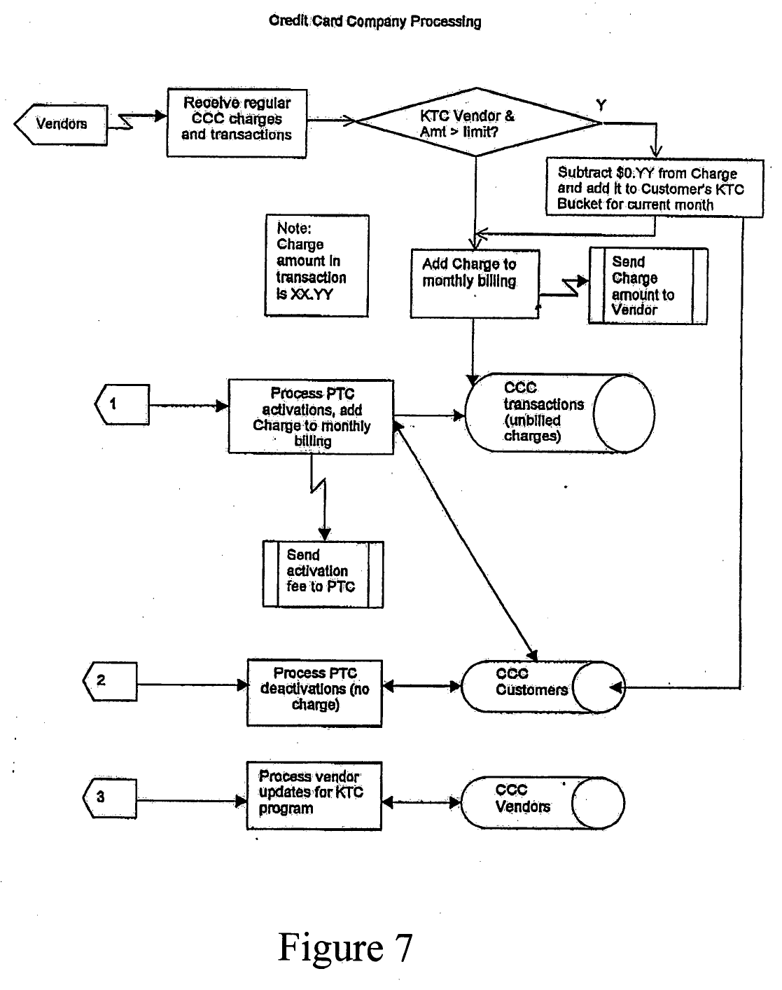

FIG. 7 is a flowchart illustrating the processing done by the financial entity (16). Transactions by participants (12) at business entity (14) are transmitted to the financial entity (16) where the transaction amount (18) is compared to see if it qualifies as a qualified transaction (22). If so, the savings amount (30) is added to the charge for monthly billing and a transaction payment is made back to the business entity (14). The qualified transaction (22) is then entered into a normal accounting process for end of the month accounting. In real time, or near real time, participant (12) and business entity (14) activations and deactivations are processed and any charges added to the appropriate accounts the end of the period accounting is then done as described herein.

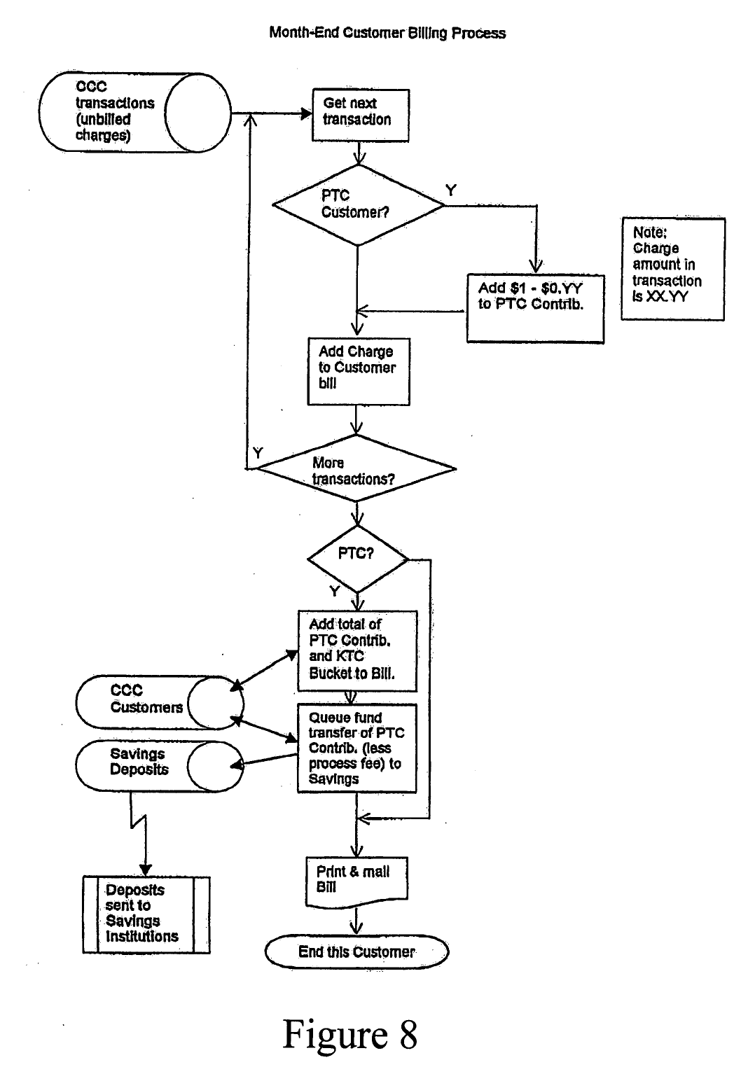

FIG. 8 is a flowchart illustrating the period end participant (12) billing process of the savings method (10). As participant accounts come due at the end of a given billing period, the participant's (12) transactions are processed. The financial entity (16) determines whether a specific customer is a participant (12), and if so goes through the statement processing in order to add the savings amount. All transactions are accounted for and a final accounting is prepared. The savings amount (30) is calculated and a process fee is deducted. The remainder of the savings amount (30) is deposited in the designated account (32). Finally, a period end statement is transmitted to the participant (12).

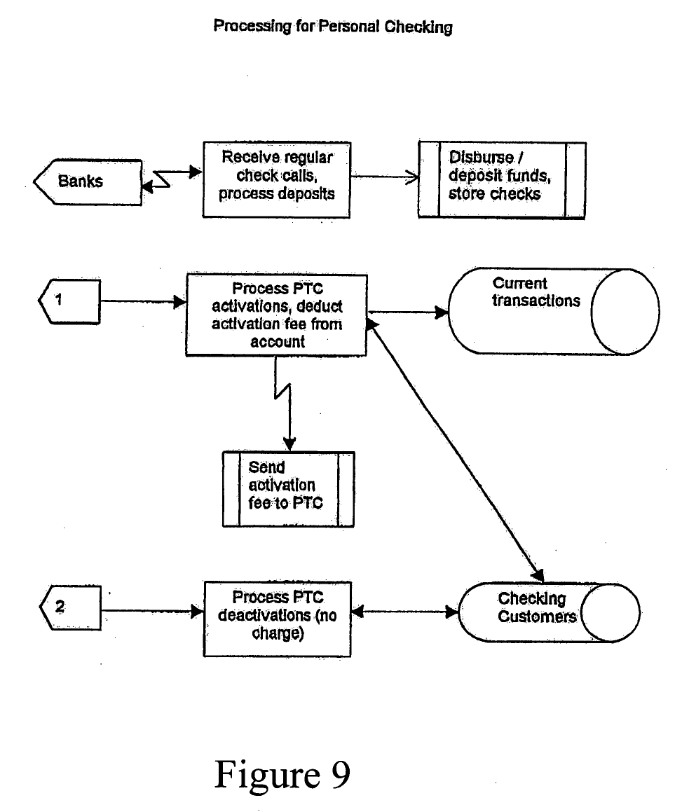

FIG. 9 is a flowchart illustrating the processing for a personal checking account of a participant (12) using the savings method (10). As checks and debits are received, transaction totals (38) are disbursed to the appropriate business entity (14). On qualified transactions (22), an additional savings amount (30) is applied to the transaction payment (26) and deducted from the participant's (12) account. The savings amount (30) is transferred to the designated account (32). Activations and deactivations are processed and, a period end statement is transmitted to the participant (12).

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that the appended claims will cover such modifications that fall within the true scope of the invention.

I claim:

1. A method for saving money comprising:
(a) entering into a qualified transaction having a transaction amount;
(b) calculating a savings amount based upon the transaction amount; and
(c) transferring the savings amount to a designated account.

2. The method of claim 1 wherein the step of entering into a qualified transaction comprises a transfer of funds from an origination account.

3. The method of claim 2 wherein the step of transferring the savings amount comprises transferring the savings amount from the origination account to the designated account.

4. The method of claim 3 wherein the origination account comprises a checking account and the designated account comprises a savings account.

5. The method of claim 1 wherein the step of calculating a savings amount comprises determining a difference between the transaction amount and the next higher whole currency denomination amount of funds.

6. The method of claim 1 further comprising the step of calculating a matching amount based on the savings amount and transferring the matching amount into the designated account.

7. The method of claim 6 wherein the matching amount is provided by a party not a party to the qualified transaction.

8. The method of claim 7 wherein the party not a party to the qualified transaction comprises a financial institution.

9. The method of claim 1 further comprising the step of calculating a differential amount based on the savings amount and transferring the differential amount into the designated account.

10. The method of claim 9 wherein the step of calculating a differential amount comprises determining a difference between the transaction amount and the next lower whole currency denomination amount of funds.

11. The method of claim 9 wherein the differential amount is provided by a party receiving funds for goods/services in the qualified transaction.

12. The method of claim 11 wherein the transaction amount is reduced by the differential amount and the savings amount is increased by the differential amount.

13. The method of claim 6 further comprising the step of calculating a differential amount based on the savings amount and transferring the differential amount into the designated account.

14. The method of claim 13 wherein the transaction amount is reduced by the differential amount and the savings amount is increased by the differential amount.

15. A method for saving money comprising:
(a) entering into a qualified transaction having a transaction amount, the qualified transaction occurring between a first party providing funds from an origination account and a second party providing goods/services in exchange for the funds;
(b) calculating a savings amount based upon the transaction amount, the savings amount comprising a difference between the transaction amount and the next higher dollar amount;
(c) transferring the savings amount from the origination account to a designated account, the designated account comprising a savings account;
(d) calculating a matching amount based on the transaction amount, the matching amount equal to the savings amount;
(e) transferring the matching amount into the designated account from a financial institution associated with an implementation of the qualified transaction;
(f) calculating a differential amount based on the transaction amount, the differential amount comprising a difference between the transaction amount and the next lower dollar amount; and
(g) withholding the differential amount from the transaction amount and transferring the differential amount from the origination account to the designated account.
